(19) United States
(12) Patent Application Publication
(10) Pub. No.: US 2006/0022383 A1
(43) Pub. Date: Feb. 2, 2006

(54) Method for creating intricate edge details in a transit door manufactured in a closed mold

(76) Inventors: Kenneth Robert Ullman, Allegany, NY (US); Darrell Scott Yochum, Cattaraugus, NY (US)

Correspondence Address: Kenneth Robert Ullman, 7167 Rte 353, Cattaraugus, NY, 14719, US

(21) Appl. No.: 10/902,665

(22) Filed: Jul. 28, 2004

(51) Int. Cl. B29C 33/00

(52) U.S. Cl. 264/313

(57) ABSTRACT

A method for creating intricate edge details in a transit door manufactured in a closed mold: with the steps of: a removeable silicone rubber insert, and self locating feature to ensure dimensional accuracy.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of composites and more specifically to a method for creating intricate edge details in a transit door manufactured in a closed mold.

Closed molding such as RTM (Resin Transfer Molding) and Light RTM have been used for years to manufacture fiber reinforced resin products. The shape of these products range from simple to complex.

One of the downfalls of a closed molding process is the inability to create various edge details. Draft angles and part geometry are very important in a closed molding process to allow the part to release from the mold.

### BRIEF SUMMARY OF THE INVENTION

The primary object of the invention is to provide a method of creating intricate edge details in a transit door without locking the part into a closed mold.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method for creating intricate edge details in a transit door manufactured in a closed mold. comprising the steps of: a removeable silicone rubber insert, and self locating feature to ensure dimensional accuracy.

### BRIEF DESCRIPTION OF THE DRAWINGS

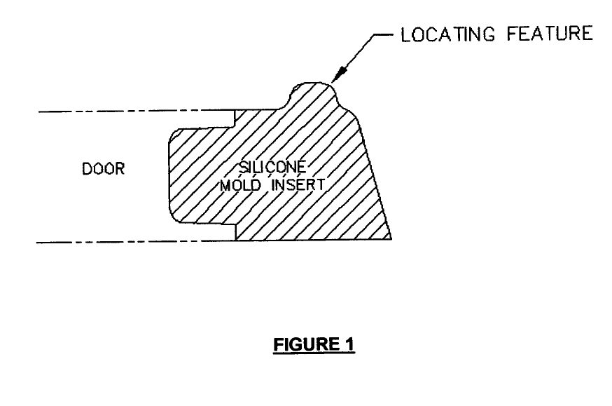

The drawings constitute a part of this specification and include exemplary embodiments to the invention, which may be embodied in various forms. It is to be understood that in some instances various aspects of the invention may be shown exaggerated or enlarged to facilitate an understanding of the invention. FIG. 1 is a cross sectional view of the mold insert.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Upon inspection of FIG. 1 it will be seen that the method of creating intricate edge details in a transit door is achieved by the means of a removeable silicone rubber mold insert. This insert allows the creation of grooves or reverse angles not typically achievable in a closed mold process. The self locating feature ensures dimensional accuracy.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method for creating intricate edge details in a transit door manufactured in a closed mold. comprising the steps of:
a removeable silicone rubber insert; and
self locating feature to ensure dimensional accuracy.
